(19) United States
(12) Patent Application Publication
(10) Pub. No.: US 2025/0122814 A1
(43) Pub. Date: Apr. 17, 2025

(54) Aircraft Engine Opening Shield System with Installation Tool

(71) Applicant: SERIAS-LEE, LLC, WASHINGTON, NC (US)

(72) Inventors: RALPH SAMUEL JARVIS, JR., BATH, NC (US); TONY LEE CHRISMON, WASHINGTON, NC (US); LARRY THOMAS GRIFFIN, JR., WASHINGTON, NC (US)

(73) Assignee: SERIAS-LEE, LLC, Washington, NC (US)

(21) Appl. No.: 18/594,043

(22) Filed: Mar. 4, 2024

Related U.S. Application Data
(63) Continuation-in-part of application No. 18/487,163, filed on Oct. 16, 2023.

(51) Int. Cl. F01D 25/28

(52) U.S. Cl. CPC F01D 25/285

(57) ABSTRACT

A system for installing a novel engine shield in the opening of an aircraft engine that is too high off the ground to be accessed by the ground support technicians while standing on the ground that includes a housing of the shield that has a front section that extends away and downward from a rear section of the housing. The front section of the housing contains an installation pole port assembly that includes an opening or port in a structure that is operably connected to a drive screw via a universal joint. In some embodiments, the installation pole port assembly is positioned to be recessed within an opening in the front section of the housing. Other versions also include a photoluminescent material applied near or around the opening in the front section of the housing.

### CROSS-REFERENCE TO RELATED APPLICATIONS

This application claims the benefit of priority to U.S. Non-Provisional application Ser. No. 18/487,163 filed on Oct. 16, 2023. The content of U.S. Non-Provisional application Ser. No. 18/487,163 filed on Oct. 16, 2023 is incorporated by reference in its entirety.

### BACKGROUND OF THE INVENTION

### (a) Field of the Invention

The present invention is in the technical field of aircraft accessories. More particularly, the present invention is in the technical field of ground support equipment.

### (b) Background Art

Previously, the inventors described and claimed a novel engine shield and installation tool that would allow ground support personnel to install and uninstall the shield while standing on the ground. The engine shield was designed to be lifted, opened and closed by a tool that would present to the installation pole port in the hub assembly of the engine shield at an angle of up to 35 degrees (with respect to the longitudinal axis of the engine shield). However, some aircraft are too tall for ground support personnel to use this system to install the engine shield in the opening of an aircraft engine. Standing on the ground, those personnel would need a pole that is more than 24 feet tall to reach the opening of some engines. Such a pole would be unwieldy and difficult to use. As a result, the inventors have developed a modified version of this engine shield and installation pole to accommodate these larger/taller aircraft.

To solve this problem, the inventors modified the installation pole port assembly of the existing shield. In prior versions of the shield, the installation pole head had a locking ring that inserted into an installation pole port on the engine shield; said port being aligned with the longitudinal axis of the center of the hub or housing that includes most of the moving parts of the engine shield. Because the locking ring on the head of the installation pole is inserted at an angle to the rest of the engine shield, the locking ring had to be able to pivot with respect to the rest of the pole head so that when it was inserted into the installation pole port, it would pivot up and down as it was rotated to prevent it from binding or becoming stuck inside the installation pole port. However, if the aircraft is tall enough, this configuration will not work as the ground support personnel will not be able to manage a pole that is long enough to insert into a horizontally oriented installation pole port. In addition, the height of the engine and thus engine shield can prevent a user from accessing an installation port that is facing horizontally (with respect to the ground). The solution was to modify the engine shield so that the head of the installation pole can be inserted into the installation pole port at a different angle.

In earlier versions of this system, the locking ring on the installation pole inserted into a port that was part of an installation port assembly. The port was operably connected to a drive screw that when turned actuated the arms inside the hub or casing of the engine shield. In the newly designed embodiments, the drive screw is operably connected to and turned by a universal joint. The installation pole port assembly has been modified so that it is oriented vertically with respect to the rest of the engine shield, i.e. the installation pole port into which the locking ring inserts faces downward towards the ground. The installation pole port is operably connected to one arm of the universal joint while the drive screw is operably connected to another arm of the universal joint. The two arms of the universal joint are connected by a cross shaft that transmits rotational motion from one arm of the universal joint to the other arm. The user thereby turns the drive screw inside the engine shield by turning one arm of the universal joint.

### BRIEF SUMMARY OF THE INVENTION

The present invention is an improved engine shield that can be installed on tall aircraft with engines that would otherwise be difficult to access from the ground. The structure and function of the internal workings of the engine shield are described in U.S. patent application Ser. No. 18/487,163. This disclosure will focus on the differences between that design and the alterations that have been made to the design to fit taller aircraft. In this disclosure, the term down or downward means toward the ground or other surface on which an aircraft is located. Up or upward indicates the opposite direction. i.e. toward the sky. The aircraft engine can be thought of as having a longitudinal axis which would be parallel to the longitudinal axis of the aircraft and would run through the center of the aircraft engine (motion around this axis is called roll). The engine can also be thought of as having a vertical axis running vertically through the center of the engine corresponding to the vertical axis of the aircraft (motion around this axis is called yaw).

As discussed previously, the engine shield includes a hub assembly that includes most of the moving parts of the engine shield. The hub assembly or casing has a front or upper section that accommodates an installation port assembly into which the head of an installation pole is inserted. More specifically, the installation pole includes a head that is positioned in an opening in an end of the pole such that it protrudes away from that opening. The head includes an internal portion and an external portion. The internal portion turns with the rotation of the pole while the exterior portion of the head does not. The external portion of the head includes a locking ring that inserts into the installation port. The installation port is an opening in a cylindrical structure that operably connects the installation port to a drive screw such that turning one causes the other to turn. As discussed in the prior patent application, the drive screw is operably connected to the shield arms such that turning the drive screw causes two sets of arms to extend or retract, based upon the direction of rotation.

The installation pole head can also have one or more locking mechanisms that prevent the rotation of the pole head in a particular direction. Preferred versions of this system include an internal locking pin positioned on an outer, annual surface of the internal portion of the head of the pole. The internal locking pin rotates with the rotation of the internal portion of the installation pole head. The movement of this internal locking pin is arrested when it encounters one or more locking grooves located on an inner surface of the installation pole. The locking grooves are aligned with the longitudinal axis of the installation pole and as a result run roughly perpendicular to the motion of the internal locking pin during rotation. Preferred embodiments of the locking mechanism include stops or grooves that arrest the movement of the pole head when rotated in either direction.

The installation pole port itself is an opening in a cylindrical structure—the installation port assembly-into which a locking ring attached to the external portion of the installation pole head inserts. When the pole head is inserted, the user pushes the pole head into the installation pole port thereby compressing an internal spring. The user then rotates the installation pole clockwise or counterclockwise until the internal locking pin engages with a locking groove or other stop thereby stopping the rotation of the pole. When the pressure on the spring is released, the locking pin slides in the locking groove. The entire engine shield can be carried on the installation pole with the pole head inserted into the installation pole port. As the installation pole is rotated while engaged with the installation pole port assembly, the locking ring that engages the installation pole port pivots up and down. The interior of the port has enough room inside of it to allow the locking ring to so pivot as it is turned. This allows the user to insert the installation pole into the pole port at an angle and still rotate the pole and turn the drive screw.

However, in designing an engine shield for taller aircraft, the angle of the installation pole to the installation pole port changes resulting in a need for a modified engine shield and/or installation pole. In these embodiments, the shape of the housing or casing that contains a lot of the moving parts of the engine shield is modified to be angled downward. More specifically, a front portion of the housing or casing extends downward as it extends away from a rear section of the housing. The angle of the front portion of the casing is not 90 degrees to the longitudinal axis of the rear section of the housing, but rather extends away from the rear section at an angle to that rear section. In other words, if the rear section of the housing is thought to have an imaginary line running thorough the longitudinal axis of that section of the housing and the installation pole port assembly is thought of as having another imaginary line running through its exact center (a longitudinal axis) then those two imaginary lines intersect at an angle. The angle between the rear section of the housing and the front section including the installation pole port assembly is more than 90 degrees and is ideally 95 decrees.

The installation pole port itself is operably connected to the drive screw through the use of a universal joint. A universal joint is a joint or coupling that includes rigid shafts attached at an angle to a cross shaft that transmits rotatory motion from one arm of the universal joint to the other arm. In this case, the universal joint is attached to and moved by the installation port assembly at one end and is operably connected to the drive screw at the opposing end such that when the installation port is rotated by the installation pole, the rotational movement is transmitted to the drive screw causing it to turn. The functioning of the drive screw and the other components of the hub assembly have been previously discussed.

The installation port assembly is recessed within this housing extension that protrudes away from the rest of the hub assembly and downward toward the ground. The positioning of this installation port assembly is an important feature of the current design. If the installation port assembly is located closer to an external surface of the hub assembly, then the user will not be able to attach the pole to the port assembly and transport the shield. It is preferably that the user be able to install the shield on the pole prior to inserting it into the opening in an aircraft engine housing.

### BRIEF DESCRIPTION OF THE SEVERAL VIEWS OF THE DRAWING(S)

FIG. 1A is a plan view of ground support personnel holding the installation pole while it is engaged with the engine shield;

FIG. 1B is a plan view of ground support personnel installing the shield into the inlet of an aircraft engine;

FIG. 1C is a bottom plan view of the opening in the front section of the housing and the installation pole port in the installation port assembly;

FIG. 2A is a top plan view of the installation pole;

FIG. 2B is a top plan view of the installation pole;

FIG. 2C is a side cross-sectional view thereof;

FIG. 2D is a side plan view of the installation pole;

FIG. 2E is a top cross-sectional view thereof;

FIG. 2F is a top cross-sectional view thereof;

FIG. 3 is a cross-sectional view of the housing of the engine shield as well as a side plan view of an end of the installation pole; and

FIG. 4 is a cross-sectional view of the housing of the engine shield with the installation pole engaged with the installation pole assembly.

### DETAILED DESCRIPTION OF THE INVENTION

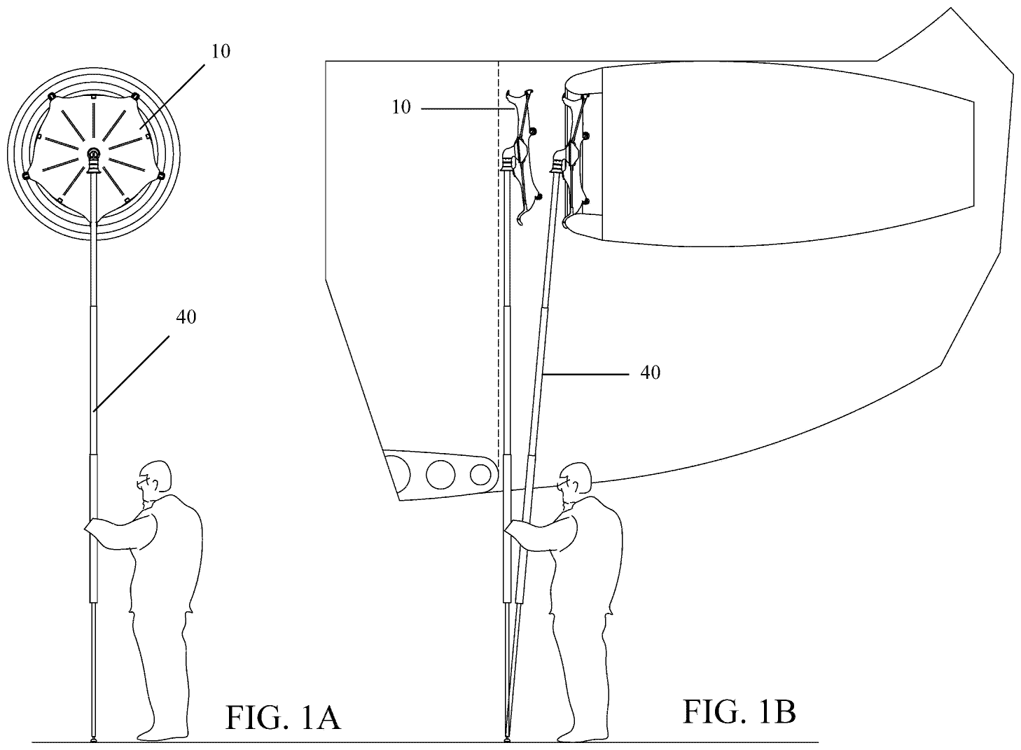

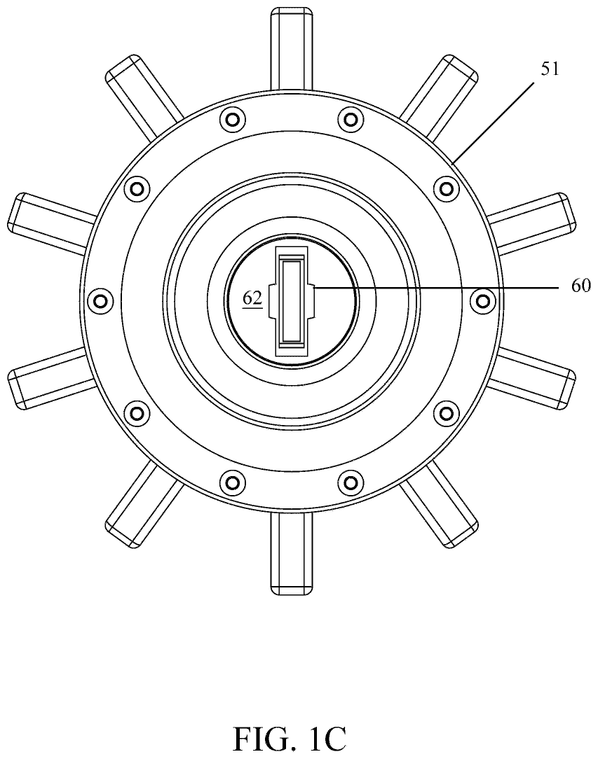

FIGS. 1A and 1B show the engine shield system being installed into the inlet of an aircraft engine. Note, a skilled artisan will appreciate that this engine shield can be used with any similar opening that needs to be protected. In FIG. 1A, there is a ground support person that is holding the installation pole 40 while it is attached to the engine shield 10. Note, the user begins installation by inserting the installation pole head (not shown) into the vertically oriented (or rear) section 54 of the engine shield housing 51 and inserting the locking ring (also not shown) into the installation pole port 60. As noted above, the installation pole port 60 is an opening in a structure that is operably connected to other components in the system. Generally, preferred embodiments of the engine shield system will use an installation pole port that is generally cylindrical, but other shapes could be used as long as they can be rotated in place.

FIG. 1C shows the installation pole port 60 as viewed when looking directly into the opening of the front section 52 of the housing 51. The shape of the installation port 60 is complementary to the pole head 41 when it is in a neutral position.

After engaging the shield with the installation pole 40, the user stands the pole 40 up vertically on one end of the pole 40. The pole 40 is telescoping so the user can adjust the height of the pole 40 as they need to. The positioning of the handle on the installation pole 40 has also been altered from the original design so that the user can grip that handle while the pole 40 is standing vertically on end. The user raises the engine shield 10 to the inlet of the aircraft engine. At this point, the user cannot easily see the topmost portion of the shield 10 as they are viewing the shield 10 from the ground. The user can see the lower section of the shield 10 so as to insert it into the aircraft inlet. The user then rotates the installation pole 40 causing the engine shield arms to extend. The functioning of the arms is discussed in a separate patent application. In extending the arms, the user can feel the shield 10 engage with the inside of the inlet.

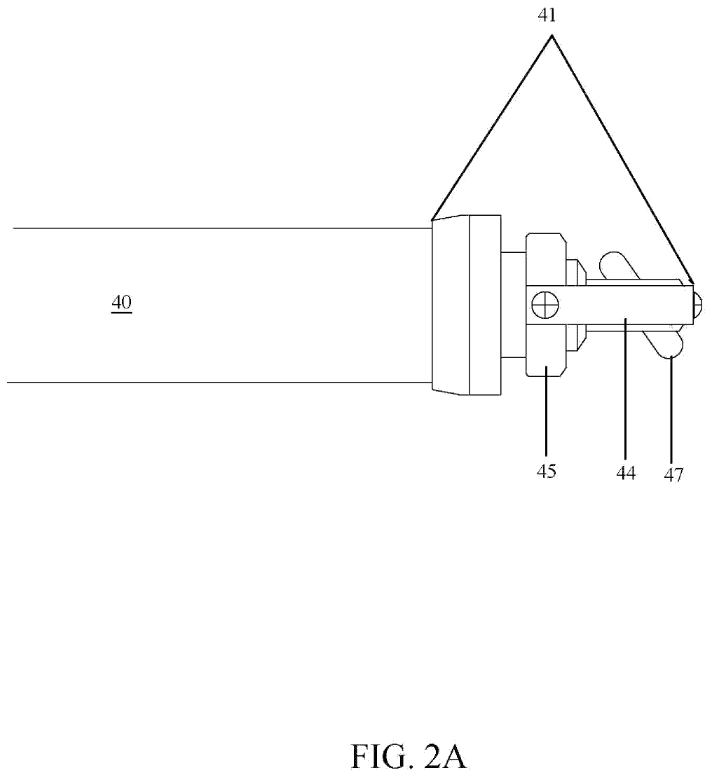

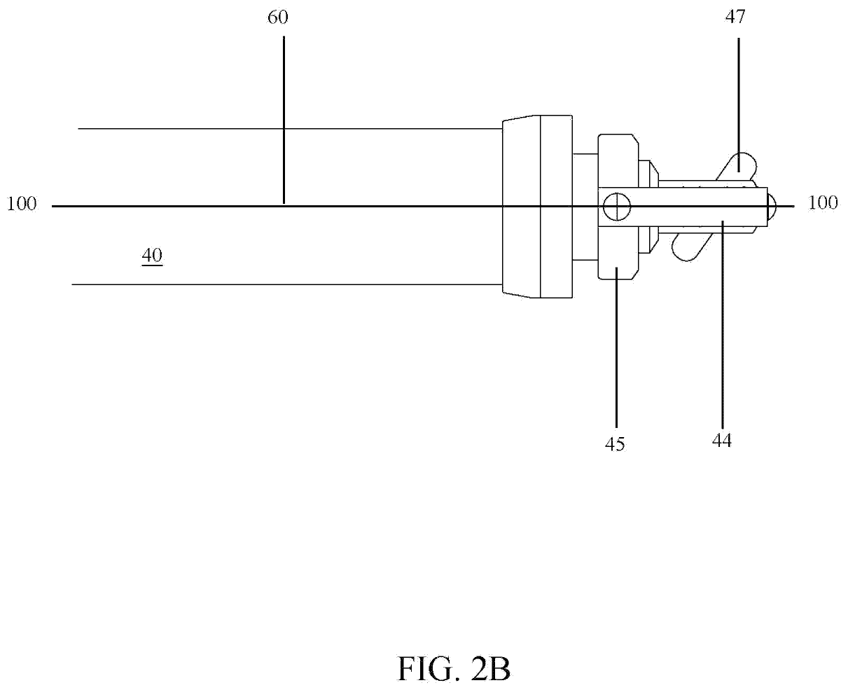

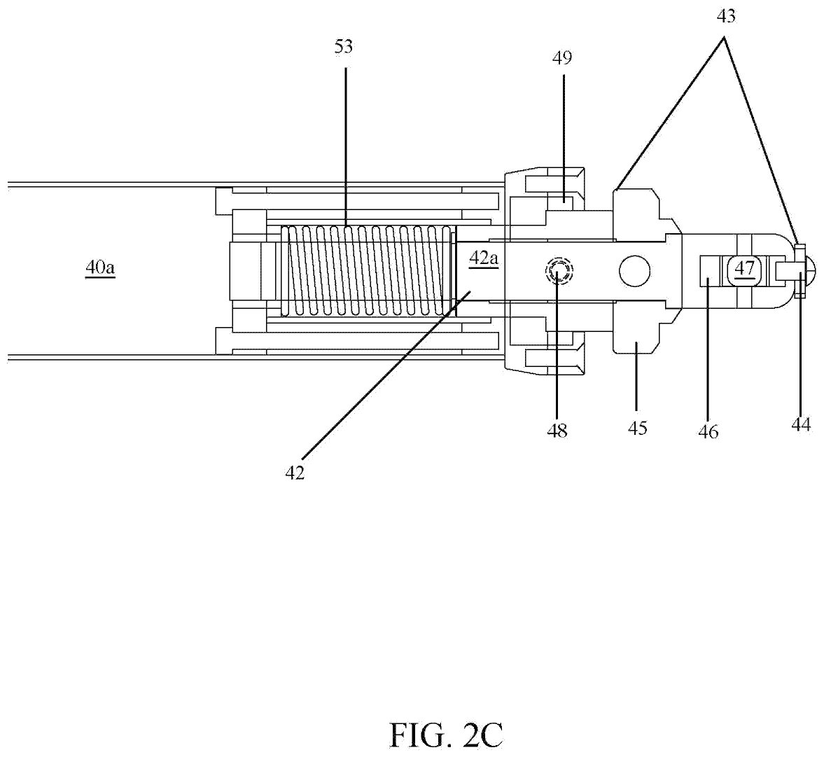

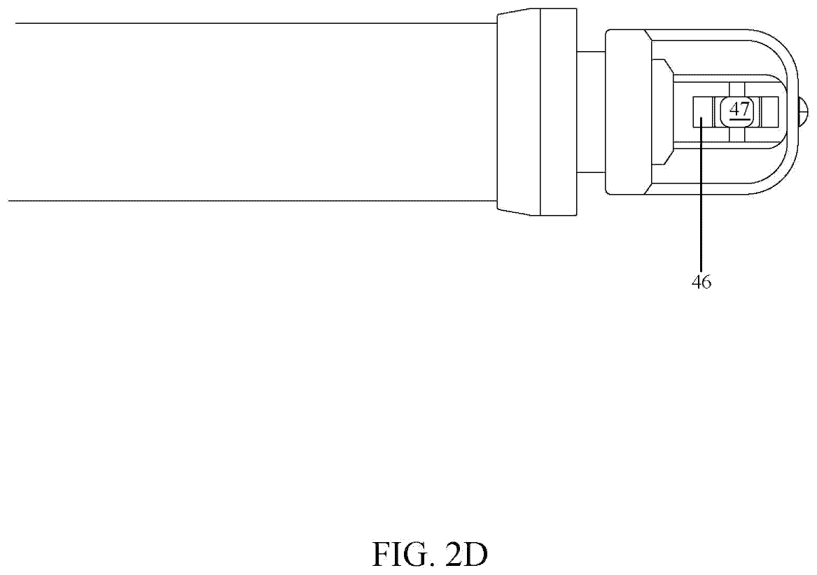

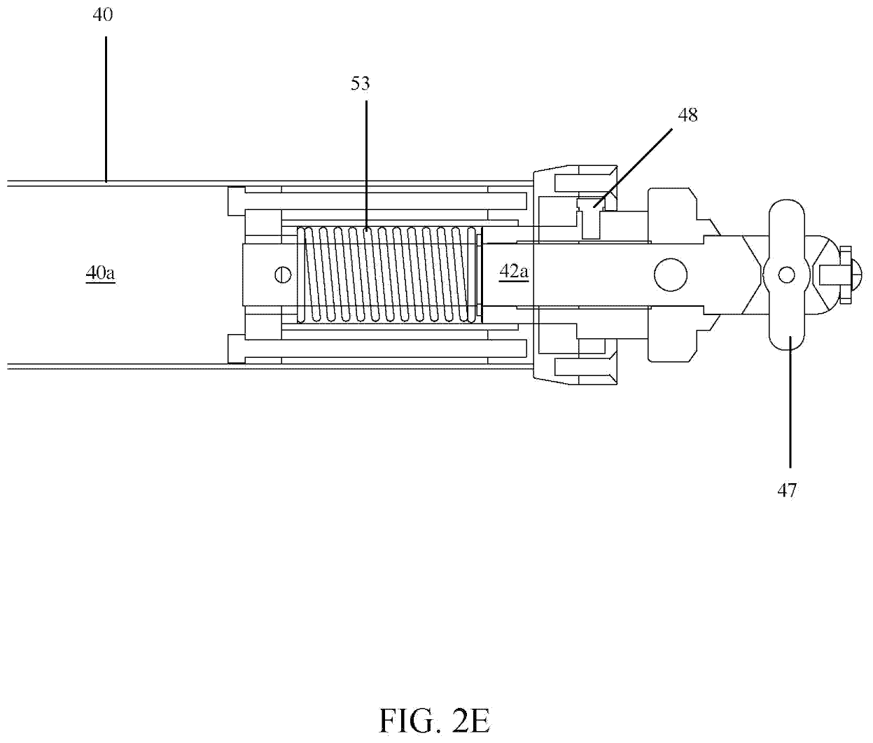

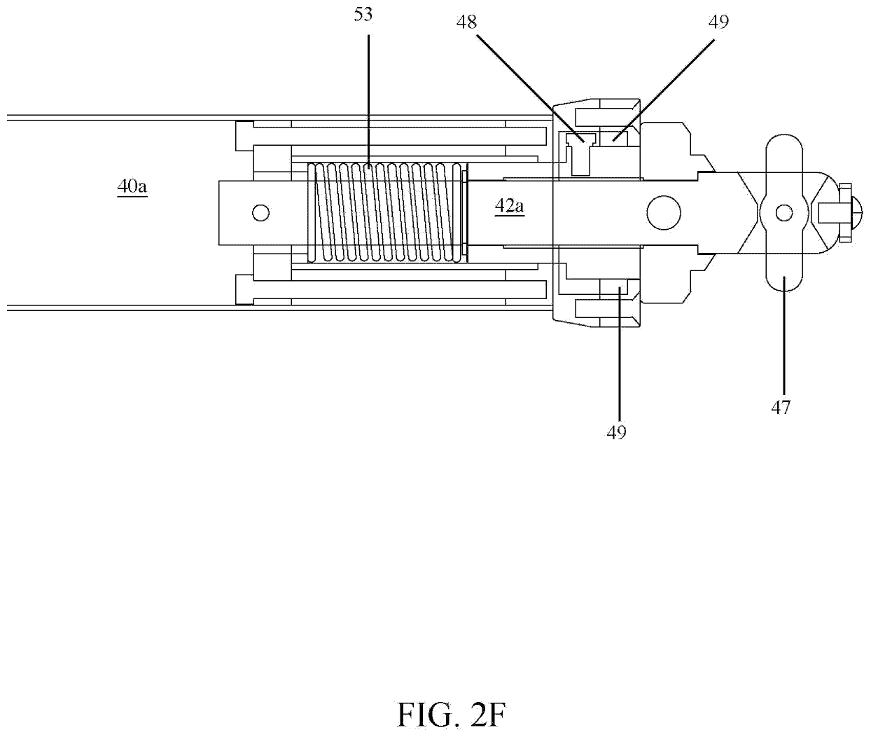

FIGS. 2A and 2B show a top view of the installation pole 40. FIG. 2C shows the same pole 40 with a cross-section cut along a longitudinal axis 100 of the installation pole 40. The installation pole 40 includes a locking pole end or head 41 that is seated in an opening (not shown) in the end of the installation pole 40. As shown in FIG. 2C, the head 41 includes an internal portion 42 and an external portion 43. The internal portion 42 turns or rotates with the rest of the installation pole 40. The external portion 43 of the head includes a locking ring 44 attached to a collar 45. In this embodiment, the locking ring 44 is an arc-shaped structure that is sized and shaped to fit into the installation pole port (not shown) and is pivotably attached to the collar 45. The collar 45 is rotatably attached to the internal portion 42 of the installation pole 40 so that the internal portion 42 of the head 41 rotates independently from the external portion 43. This allows the user to insert the installation pole head 41 into a port or other structure that holds the locking ring 44 in place while the user turns the rest of the installation pole 40 thereby causing the internal portion 42 of the head 41 to rotate while the external portion 43 is held stationary in the installation port 60.

FIGS. 2C and 2D show that the internal portion 42 of the head 41 includes a cavity 46 that holds the external locking pin 47. The external locking pin 47 is pivotably attached to the internal portion 42 of the head 41 and is positioned inside the cavity 46. The head 41 of the installation pole does not pivot when the installation pole 40 is rotated, but rather the interior of the installation pole port 31 has enough extra room that the locking ring 44 can move around inside the port 31 as it is rotated at an angle to the installation pole port 31. The installation pole 40 is locked into the installation pole port 60 when the user rotates the pole 40 and thereby rotates the internal portion 42 of the head 41 until the locking ring 44 and the external locking pin 47 are perpendicular or substantially perpendicular to each other. As the locking pole end 41 is rotated under the guidance of the user, the external locking pin 47 pivots up and down so as not to bind or arrest the movement of the locking pole end 41. In addition, the locking ring 44 is pivotably connected to the collar 45 so that its position can be adjusted based upon the angle at which it is inserted and there is room for it to pivot up and down in response to the rotation of the installation pole head 41.

FIGS. 2E and 2F show the internal locking mechanism present in preferred embodiments and the inventors' anticipated best mode of the installation pole 40. This locking mechanism includes an internal locking pin 48 positioned on an outer, annual surface 42a of the internal portion 42 of the head 41 that engages one or more locking grooves 49 located on an inner surface 40a of the installation pole 40 when the locking pole end 41 is rotated such that the locking pin 48 and the locking groove 49 are aligned. FIG. 2E shows the locking pin engaged in one of the locking grooves 49. FIG. 2F shows the same locking pin 48 disengaged from the same locking groove 49. The locking grooves 49 are parallel or substantially parallel to or in line with the longitudinal axis of the installation pole. Preferred embodiments of the installation pole 40 have more than one locking groove 49 such that the internal locking pin 48 can be inserted into more than one locking groove 49. One locking groove 49 may be positioned to lock the locking pole end 41 in place when it is rotated clockwise, another groove may be positioned to lock the locking pole head 41 in place when the installation pole 40 is rotated in the opposite direction and a third groove may accommodate the locking pin 48 when the locking ring 44 and external locking pin 47 are aligned in a “neutral” position. In preferred embodiments and the inventors' anticipated best mode, the installation pole 40 has three locking grooves 49 and the internal portion 42 of the head 41 includes a spring 50 that is compressed by the user to remove the locking pin 47 from a locking groove 49 and allow the user to turn the installation pole head 41 clockwise or counterclockwise. When the user stops applying a pushing force to the head 41, the spring 50 relaxes causing the internal portion 42 of the head 41 to move outward away from the rest of the installation pole 40 (parallel to the installation pole's longitudinal axis) thereby pushing the locking pin 47 into a locking groove 49. In preferred embodiments, the installation lock point and the removal lock point are 180 degrees from one another with the neutral lock point being between the two at 90 degrees from either. The neutral position is also the position in which the installation pole can be inserted into and taken out of the installation pole port 60. The other two positions represent positions in which the locking ring 44 is rotated to turn the installation port 60 to either expand or raise the shield arms to contract or lower them for removal and storage. When the locking internal portion 42 of the pole head 41 is locked in place using the locking mechanism herein described, rotating the pole causes the installation pole port (not shown) to rotate with the installation pole 41.

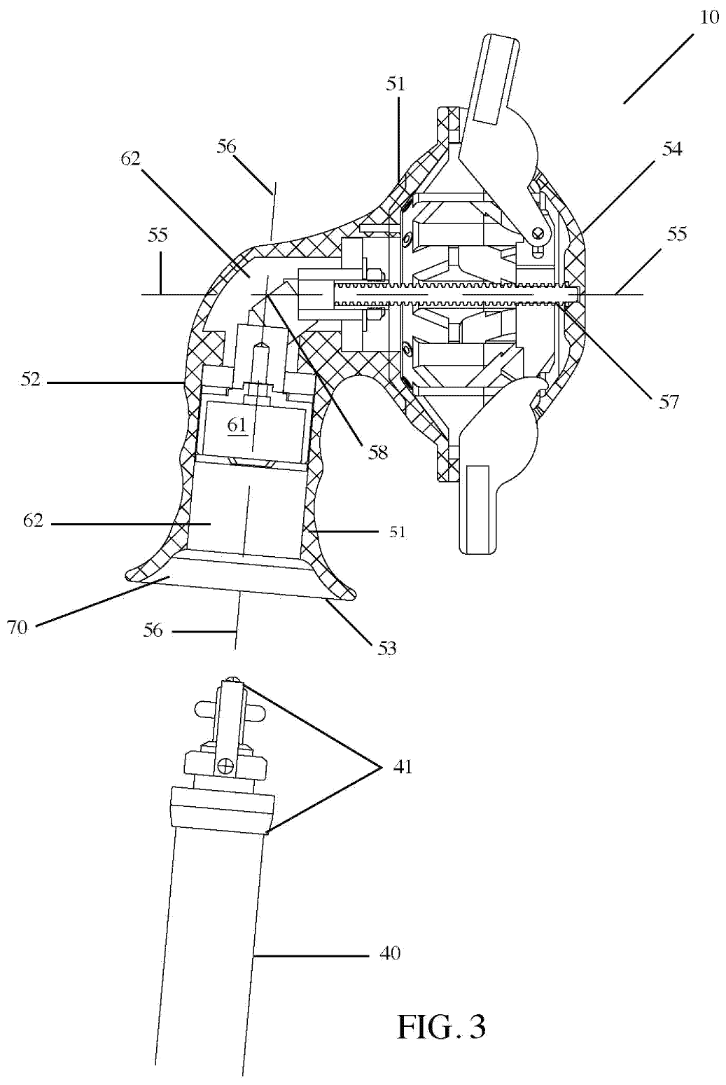

FIG. 3 shows a cross-sectional view of the housing 51 of the engine shield 10 as well as a side plan view of an end of the installation pole 40 including the installation pole head 41. FIG. 3 shows that the casing or housing 51 of the shield 10 includes a rear section 54 that is positioned horizontally with respect to the ground and a front section 52 that extends away from the rear section 54 at an angle 58 and angles downward toward the ground. FIG. 3 also shows an imaginary line that runs through the longitudinal axis 55 of the rear section 54 of the housing 51 including the drive screw 57 that activates or moves the arms of the shield 10. This longitudinal axis 55 of the rear section 54 of the housing 51 is parallel to the longitudinal axis of the aircraft and runs through the center of the rear section 54 of the housing 51 from one end to the other. The front section 52 of the housing 51 extends away from the rear section 54 and downward so that ground support personnel can insert the installation pole 40 into the installation pole port 60. Note, the angle of the front section 54 of the casing is not 90 degrees to the longitudinal axis 55 of the rear section 54 of the housing 51, but rather extends away from the rear section 54 at an angle to that rear section 54. In other words, if the rear section 54 of the housing 51 is thought to have an imaginary line running thorough the longitudinal axis 55 of that section of the housing 51 and the installation port assembly 61 has another imaginary line running through its center or longitudinal axis 56, then those two imaginary lines intersect at an angle 58. The angle 58 between the rear section 54 of the housing 51 and the front section 52 including the installation pole port assembly 61 is more than 90 degrees and is ideally 95 decrees.

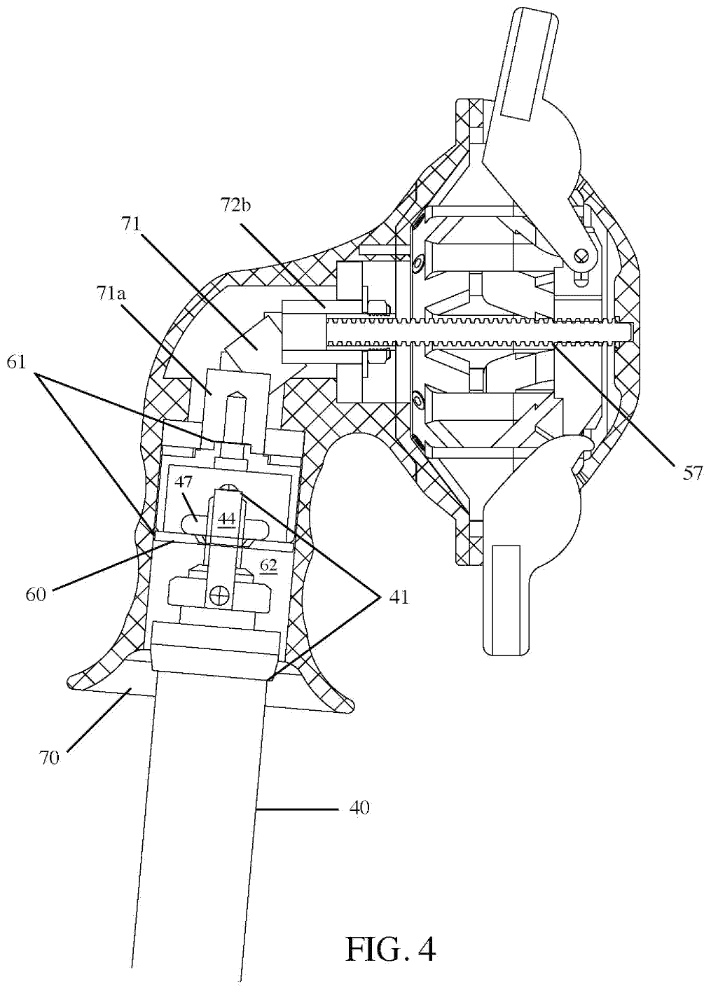

FIG. 4 shows the head 41 of the installation pole 40 inserted into the installation pole port 60. As previously discussed, the user rotates the installation pole 40 such that the locking ring 44 and external locking pin 47 are parallel with each other. The user then inserts the head 41 into the installation pole port 60 pushing the head 41 to compress the spring 50. The user rotates the installation pole 40 thereby turning the internal portion of the head 41 with the external locking pin 47 until the internal locking pin 48 hits one of the locking grooves 49 arresting the rotational movement. The user then releases pressure on the installation pole 40 allowing the spring 50 to expand or release thereby moving the internal locking pin 48 further into the locking groove 49. The pole head 41 is at that point locked in place. The shield 10 is then positioned inside the engine inlet and the user rotates the pole 40 causing the pole head 41 to turn the installation pole port 60. This rotational movement is transmitted to the drive screw 57 through the universal joint 71.

FIGS. 3 and 4 also show that the position of the installation pole port assembly 61 has been altered in this design. This assembly 61 has been moved further into a cavity 62 or space that runs the entire length of the front section 52 of the housing 51 and into the rear section 54 of the housing 51 which holds the moving parts of the shield. The recessed installation pole port assembly 61 makes the engine shield 10 easier to carry with the installation pole 40 inserted into the installation port 60. In addition, FIGS. 3 and 4 show the photoluminescent ring 70 that encircles the opening 53 in the front section 52 of the housing 51. Applying a photoluminescent material 70 to the outside of the housing 51 improves visibility when ground support personnel are inserting the installation pole 40 into the installation pole port 60 under low lighting. This can be particularly useful when removing the shield 10 from an aircraft at night—it allows the ground support personnel to more easily see where to insert the pole head 41.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

Reference throughout the specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout the specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

It is understood that the above-described embodiments are only illustrative of the application of the principles of the present invention. The present invention may be embodied in other specific forms without departing from its spirit or essential characteristics. The described embodiment, including the best mode, is to be considered in all respects only as illustrative and not restrictive. The scope of the invention is, therefore, indicated by the appended claims, if any, in conjunction with the foregoing description.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

Clause 1. A system for installing an engine shield into the inlet of an aircraft engine comprising:
a housing having a front section positioned vertically with respect to a horizontally positioned rear section; and
an installation port comprising an opening in a cylindrical structure that is operably connected to a drive screw located in the rear section of the housing.
   Clause 2. The system of clause 1 further comprising a universal joint connected at a first end to the drive screw and at a second end to the cylindrical structure such that rotating the installation pole port turns the universal joint and causes the drive screw to rotate.
   Clause 3. The system of clause 2 further comprising:
an opening in the front section of the housing; said opening communicates with a cavity that runs the length of the front section of the housing; and
the installation pole port and cylindrical structure are positioned entirely inside the front section of the housing such that the installation pole port is recessed with respect to the portion of the front section that encircles the opening in the front section of the housing.
   Clause 4. The system of clause 3 further comprising a photoluminescent material positioned proximate to the opening in the front section of the housing.
   Clause 5. The system of clause 1 wherein a longitudinal axis of the rear section of the housing intersects a longitudinal axis of the installation pole port at an angle that is not a right angle.
   Clause 6. A system for installing ground support equipment in the opening of an aircraft engine comprising:
a universal joint;
an installation pole port that comprises an opening in a cylindrical structure that is operably connected at one end to the universal joint; and
a drive screw operably connected to a second end of the universal joint.
   Clause 7. The system of clause 6 further comprising:
a housing with a front section and a rear section; and
an opening in a first end of the front section of the housing that communicates with a cavity that extends from the front section of the housing into the rear section of the housing;
wherein the installation pole port and the cylindrical structure are positioned inside of the cavity and are recessed with respect to the opening in said front section of the housing.
   Clause 8. The system in clause 7 wherein the front section of the housing extends away and downward from the rear section of the housing.
   Clause 9. The system in clause 8 wherein said front section of the housing extends away from a longitudinal axis of the rear section of the housing at an obtuse angle to said longitudinal axis.
   Clause 10. The system of clause 9 further comprising a photoluminescent material positioned proximate to the opening in the front section of the housing.
   Clause 11. A system for installing a protective shield into an opening of an aircraft engine comprising:
a housing comprising:
a rear section that is positioned horizontally;
   a front section that is positioned vertically with respect to the rear section;
an installation pole port comprising an opening in a cylindrical structure that is positioned in the front section of the housing; and
a universal joint operably connected to the cylindrical structure.
   Clause 12. The system of clause 11 further comprising a drive screw that is operably connected to the universal joint.
   Clause 13. The system in clause 11 further comprising:
an opening in the front section of the housing that communicates with a chamber extending at least part of the length of the front portion of the housing wherein the installation pole port is positioned inside the chamber of the housing such that it is recessed with respect to the opening.
   Clause 14. The system of clause 11 wherein a longitudinal axis of the rear section of the housing intersects a longitudinal axis of the installation pole port at an angle that is not a right angle.
   Clause 15. The system of clause 11 a longitudinal axis of the rear section of the housing intersects a longitudinal axis of the installation pole port forming an inside and an outside angle; wherein the inside angle is obtuse.

We claim:

1. A system for installing an engine shield into the inlet of an aircraft engine comprising:
a housing having a front section positioned vertically with respect to a horizontally positioned rear section; and
an installation port comprising an opening in a cylindrical structure that is operably connected to a drive screw located in the rear section of the housing.

2. The system of claim 1 further comprising a universal joint connected at a first end to the drive screw and at a second end to the cylindrical structure such that rotating the installation pole port turns the universal joint and causes the drive screw to rotate.

3. The system of claim 2 further comprising:
an opening in the front section of the housing; said opening communicates with a cavity that runs the length of the front section of the housing; and
the installation pole port and cylindrical structure are positioned entirely inside the front section of the housing such that the installation pole port is recessed with respect to the portion of the front section that encircles the opening in the front section of the housing.

4. The system of claim 3 further comprising a photoluminescent material positioned proximate to the opening in the front section of the housing.

5. The system of claim 1 wherein a longitudinal axis of the rear section of the housing intersects a longitudinal axis of the installation pole port at an angle that is not a right angle.

6. A system for installing ground support equipment in the opening of an aircraft engine comprising:
a universal joint;
an installation pole port that comprises an opening in a cylindrical structure that is operably connected at one end to the universal joint; and
a drive screw operably connected to a second end of the universal joint.

7. The system of claim 6 further comprising:
a housing with a front section and a rear section; and
an opening in a first end of the front section of the housing that communicates with a cavity that extends from the front section of the housing into the rear section of the housing;
wherein the installation pole port and the cylindrical structure are positioned inside of the cavity and are recessed with respect to the opening in said front section of the housing.

8. The system in claim 7 wherein the front section of the housing extends away and downward from the rear section of the housing.

9. The system in claim 8 wherein said front section of the housing extends away from a longitudinal axis of the rear section of the housing at an obtuse angle to said longitudinal axis.

10. The system of claim 9 further comprising a photoluminescent material positioned proximate to the opening in the front section of the housing.

11. A system for installing a protective shield into an opening of an aircraft engine comprising:
a housing comprising:
a rear section that is positioned horizontally;
a front section that is positioned vertically with respect to the rear section;
an installation pole port comprising an opening in a cylindrical structure that is positioned in the front section of the housing; and
a universal joint operably connected to the cylindrical structure.

12. The system of claim 11 further comprising a drive screw that is operably connected to the universal joint.

13. The system in claim 11 further comprising:
an opening in the front section of the housing that communicates with a chamber extending at least part of the length of the front portion of the housing wherein the installation pole port is positioned inside the chamber of the housing such that it is recessed with respect to the opening.

14. The system of claim 11 wherein a longitudinal axis of the rear section of the housing intersects a longitudinal axis of the installation pole port at an angle that is not a right angle.

15. The system of claim 11 a longitudinal axis of the rear section of the housing intersects a longitudinal axis of the installation pole port forming an inside and an outside angle; wherein the inside angle is obtuse.
